(19) United States
(12) Patent Application Publication
(10) Pub. No.: US 2026/0244847 A1
(43) Pub. Date: Aug. 20, 2026

(54) CALIBRATED MODEL INTERVENTION WITH CONFORMAL THRESHOLD

(71) Applicant: THE TORONTO-DOMINION BANK, TORONTO (CA)

(72) Inventors: Jesse Cole Cresswell, TORONTO (CA); Yi Sui, Newmarket (CA); Shiyi Hou, TORONTO (CA); Maksims Volkovs, TORONTO (CA); Ga Wu, Halifax (CA); Naihe Feng, Halifax (CA)

(21) Appl. No.: 19/320,493

(22) Filed: Sep. 5, 2025

Related U.S. Application Data
(60) Provisional application No. 63/760,994, filed on Feb. 20, 2025.

(51) Int. Cl. G06F 40/169; G06F 16/3329; G06F 16/335

(52) U.S. Cl. CPC G06F 40/169; G06F 16/33295; G06F 16/335

(57) ABSTRACT

A calibrated query response system generates a response to a query, the response having a statistical guarantee of a quality, such as the quality of factuality. The calibrated query response system generates an initial response using retrieval-augmented generation (RAG). The initial response is split into a plurality of sub-claims, and each sub-claim is scored, for example based on the query and a set of documents retrieved for RAG. The scores of each sub-claim are validated against a calibrated threshold, where the calibrated threshold has been determined using conformal prediction and provides a statistical guarantee of the quality (e.g., factuality). A filtered response is generated comprising the validated sub-claims.

### CROSS-REFERENCE TO RELATED APPLICATION

This application claims the benefit of U.S. Provisional Application No. 63/760,944, filed Feb. 20, 2025, the contents of which is hereby incorporated by reference in its entirety.

### BACKGROUND

This disclosure relates generally to retrieval-augmented generation (RAG) systems and more particularly to producing calibrated quality guarantees for responses generated by RAG systems.

Existing research on RAG mostly focuses on improving overall query-answering accuracy, leading to partially incorrect outputs and hard-to-detect errors. Human evaluations reveal that RAG-based query-answering systems sometimes misinterpret user queries, struggle with reasoning in unseen scenarios, and may generate claims that are irrelevant or even contradictory to the provided documents.

Ensuring the quality of responses generated by RAG systems remains a challenge, prompting research into various evaluation solutions. One straightforward way to quantify the quality of responses generated by RAG systems is through auto-evaluation based on well-defined metrics. Unfortunately, popular auto-evaluation methods require ground-truth answers at inference time, making them impractical in real applications where RAG systems are applied to new queries with unknown “ground-truth” answers.

### SUMMARY

A calibrated query response system provides conformal guarantees to retrieval-augmented generation (RAG) responses, tailoring responses to maintain accuracy (or another quality) with a conformal guarantee for sub-claims with respect to a quality (such as accuracy/truthfulness). The calibrated query response system retrieves documents to be used as context for responding to a query with a language model and generates an initial response through a RAG process. The initial response is parsed to identify discrete sub-claims that are evaluated with a scoring function calibrated for a particular quality, such that sub-claims below the calibrated threshold can be excluded from the response. This approach leads to substantially more retained response content compared to existing solutions that attempt to ensure response quality. Instead of focusing on overall query-answering accuracy, this approach assesses the quality of sub-claims within generated responses using scoring techniques, ensuring the soundness of evaluations through statistical guarantees.

When the quality is factuality, the calibrated query response system can ensure group conditional factuality spanning multiple sub-domains without requiring manual annotation of conformal set validity or ground-truth at inference time, making it highly adaptable for complex applications. In empirical evaluations on four benchmark datasets from two domains, Wikipedia and medicine, the experimental results show retaining up to 60% more sub-claims from the output in query-answering tasks for the same factuality level compared to existing baselines. Hence, embodiments provide substantial improvements to the quality and quantity of information output in response to a query compared to prior approaches.

### BRIEF DESCRIPTION OF THE DRAWINGS

FIG. 1 is a networked environment for a calibrated query response system, according to one or more embodiments.

FIG. 2 is an example block diagram of the calibrated query response system, according to one or more embodiments.

FIG. 3 is an example pipeline for generating an initial response by a RAG system, according to one or more embodiments.

FIG. 4 is an example query, response, and bar graph of scored sub-claims and conformal scores, according to one or more embodiments.

FIG. 5 shows generating a calibrated conformal threshold from calibration data, according to one or more embodiments.

FIG. 6 is a flow diagram of a method for generating a response using the calibrated query response system at inference time, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

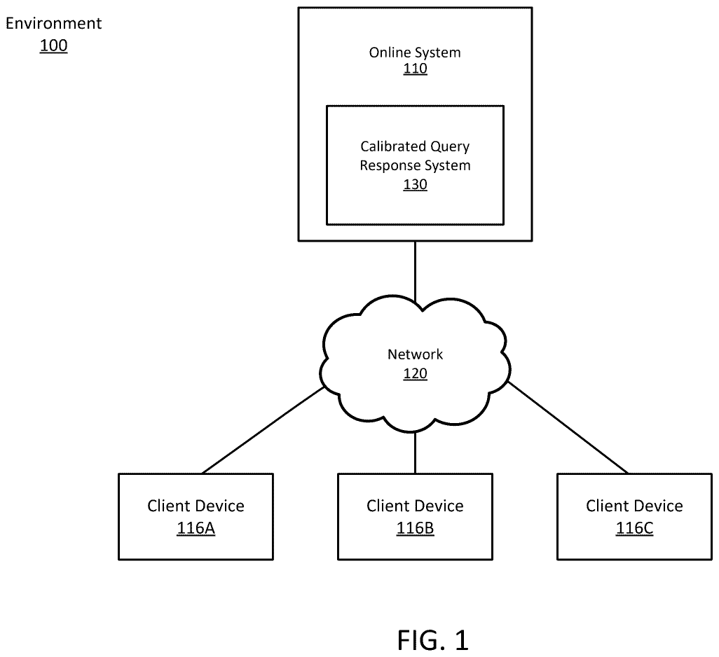

FIG. 1 is a networked environment 100 for a calibrated query response system 130, according to one or more embodiments. The networked environment 100 includes an online system 110 hosting the calibrated query response system 130 and one or more client devices 116A, 116B, 116C. The calibrated query response system 130 receives and responds to queries received from the client devices 116 based, at least in part, on a document repository. Particularly, the calibrated query response system 130 generates a response to the query based on relevant documents and evaluates sub-claims of the response to provide a calibrated quality guarantee that excludes sub-claims lacking a desired quality, such as factuality.

A network 120 communicatively couples the online system 110 and the one or more client devices 116A, 116B, 116C to one another. The network 120 can be the Internet or an intranet. The network 120 can be implemented as any type of computing network, with various wired and/or wireless connections, and may include a local area network (LAN), a wide area network (WAN), or a cloud computing network, among others.

The online system 110 provides various services and operations to enable a particular client device 116 to interface with the calibrated query response system 130. Such operations include transmitting data to, receiving data from, and processing data generated by the client device 116. The data exchanged between the online system 110 and the client device 116 includes functions (e.g., commands to invoke functions) as well as payload data (e.g., files, text, image, audio, video, or other multimedia data). In some examples, the data exchange includes user-generated queries received by the online system 110 from the client device 116, and query responses generated by the calibrated query response system 130 that are transmitted by the online system 110 to the client device 116. Data exchanges within the networked environment 100 are invoked and controlled through functions available via user interfaces (UIs) presented for display on the client device 116.

The calibrated query response system 130 generates a response to a query that curates sub-claims with respect to a particular quality, with calibration that provides a statistical guarantee of the likelihood that the response does not (or does, depending on the quality) include sub-claims with the quality. One example quality is factuality (e.g., to provide a response that excludes non-factual sub-claims). Examples of other qualities include relevance (e.g., being relevant to the original query), toxicity (e.g., having removed all harmful, offensive, or inappropriate content), or more specific qualities to filter for, such as hate speech or self-harm, among other examples. Additional example qualities can include content safety (e.g., the system is calibrated to filter out unsafe content or content related to parental controls), bias (e.g., calibrated to minimize bias in language), and additional safety and security characteristics (e.g., preventing unauthorized access to documents or other information). As discussed further below, the calibrated statistical guarantee provides a calibrated confidence level that all sub-claims within the response satisfy the quality (e.g., factual, relevant, non-toxic, etc.)

The query is a user-generated query received from the client device 116 over the network 120, according to some examples. Additionally, or alternatively, the query may be non-user-generated in some examples, such as a system-generated query or a query generated by another language model.

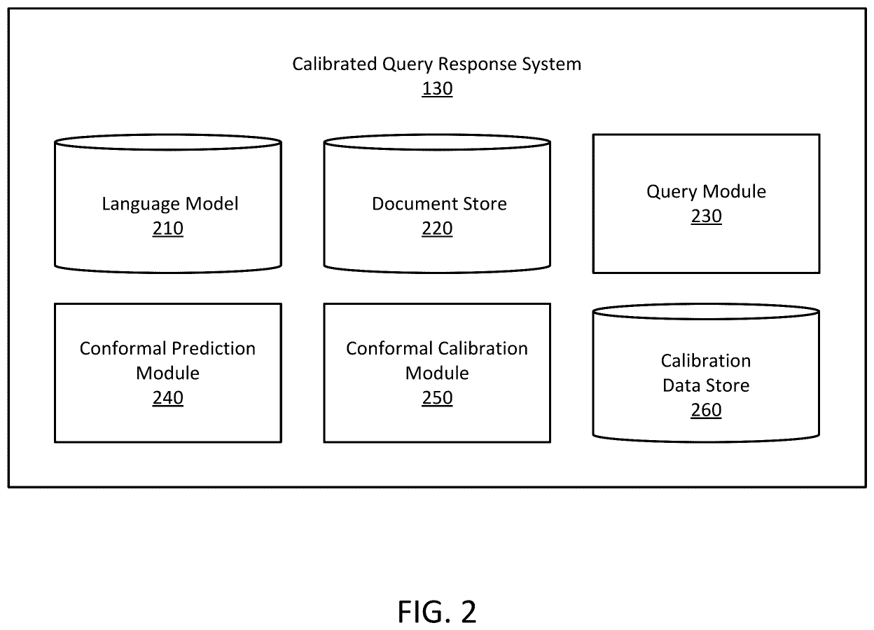

FIG. 2 is an example block diagram of the calibrated query response system 130, according to one or more embodiments. The calibrated query response system 130 comprises a language model 210, a document store 220, a query module 230, a conformal prediction module 240, a conformal calibration module 250, and a calibration data store 260. The models, modules, and stores of the calibrated query response system 130 are capable of exchanging information among each other. This functionality may be distributed differently among various components and across individual systems in various embodiments.

As an overview, the calibrated query response system 130 uses the query module 230 to generate an initial response through a retrieval-augmented generation (RAG) process. The conformal prediction module 240 parses the initial response into sub-claims which are evaluated for quality using calibrated conformal functions. The document store 220 provides documents as context for the query module 230 and the sub-claim quality evaluations by the conformal prediction module 240. The conformal calibration module 250 determines conformal thresholds during a calibration stage. The conformal thresholds are used by the conformal prediction module 240 at inference time to evaluate sub-claims for the quality and exclude sub-claims with scores below the calibrated threshold. The calibration data store 260 provides storage for data relating to the calibration, including the conformal thresholds.

The language model 210 is a generative computer model configured to process language input and generate language outputs. The language model 210 may be trained on a large corpus of language, such that it learns to generate language outputs from various language inputs, which may include one or more prompts, context, or other language inputs. The language model 210 typically includes a sequence of computer modeling layers having tunable parameters. The layers may model various types of operations and connections input data from, e.g., prior layers of the language model 210. The various layers may include encoding layers, fully-connected layers, activation layers, attention layers, recurrent layers, and so forth according to the particular characteristics of the language model 210.

The language model 210 may be implemented in various architectures and structures in various embodiments. The language model 210 may be a “large” language model (LLM), such as a generative pretrained transformer (GPT), according to some embodiments. Additionally, or alternatively, the language model 210 can include one or more bidirectional encoder representations from transformers (BERTs). The language model 210 may be a pre-trained model and can be guided by prompt engineering or be otherwise fine-tuned for specific tasks, such as for responding to queries as discussed below. In some embodiments, multiple language models 210 may be used.

The language model 210 may include a transformer architecture or other attention-based mechanisms, according to some embodiments. In general, transformer architecture includes four main components: tokenizer(s), an embedding layer, a plurality of transformer layers, and an un-embedding layer. The tokenizer(s) converts each word or segment of characters of text into a token, and the embedding layer converts the tokens and their respective positions into vector representations. The transformer layers carry out repeated transformation of the vector representations to extract linguistic information. The un-embedding layer converts the final vector representations generated by the transformer layers into a probability distribution of tokens, reversing the embedding layer.

The embedding layer may further include positional encoding, which provides a vector representation of the relative positions of the tokens within a sequence (e.g., where the sequence is the pre-tokenization sentence or phrase). The positional encoding vector of each token provides the transformer layers with additional semantic information.

The transformer layers use a multi-headed attention mechanism to process the vectorized tokens to determine semantic meaning between the tokens and generate an output (e.g., response to a query, a translation of the input, etc.). The transformer layers can include encoder-decoder blocks. The encoder converts an input vectorized token sequence into an input sequence representation that conveys semantic meaning; the decoder processes the input sequence representation to generate an output token sequence (e.g., response, translation, etc.). The encoder typically includes a multi-headed self-attention layer that determines representations of the importance of different vectorized tokens in the sequence and a feed-forward neural network that further refines the representations to generate the input sequence representation. The decoder typically includes a multi-headed self-attention layer that can be “masked” to bar the decoder's attention from future tokens in the sequence, a multi-headed cross-attention layer to manage the decoder's attention on the encoder-generated outputs, and a feed-forward neural network for refining the generated output token sequence (e.g., response, translation, etc.).

The language model 210 may be implemented in any suitable architectures. For example, the language model 210 may alternatively be implemented as a recurrent neural network (RNN), for example, with long short-term memory (LSTM) or with other model architectures and layers.

The document store 220 stores documents used by the calibrated query response system 130. The documents stored in the document store 220 provide context in RAG processes performed by the query module 230 and in conformal prediction processes (namely, scoring) by the conformal prediction module 240. According to some embodiments, the documents stored in the document store 220 are internal documents or documents that are not publicly available. In some embodiments, the documents stored in the document store 220 are local copies of publicly available information.

The document store 220 uses computer-readable media to store documents and may use databases to organize the stored documents. The documents stored in the document store 220 can be files of any format, such as plain and/or formatted text (e.g., .doc/.docx, ASCII, HTML, .md, .pdf, .txt, .xml, .json, etc.), spreadsheet and/or tabulated data (e.g., .xls/.xlsm, .csv, etc.), graphics (e.g., .jpeg, png, .tiff, vector graphics, 3D graphics, etc.), database files (e.g., relational databases, non-relational database, distributed databases, etc.), or compressed files (e.g., .zip, .bin, etc.). Types of documents can include financial records, research papers, scientific data, user data, source code files, and any other documents that provide relevant context for answering queries.

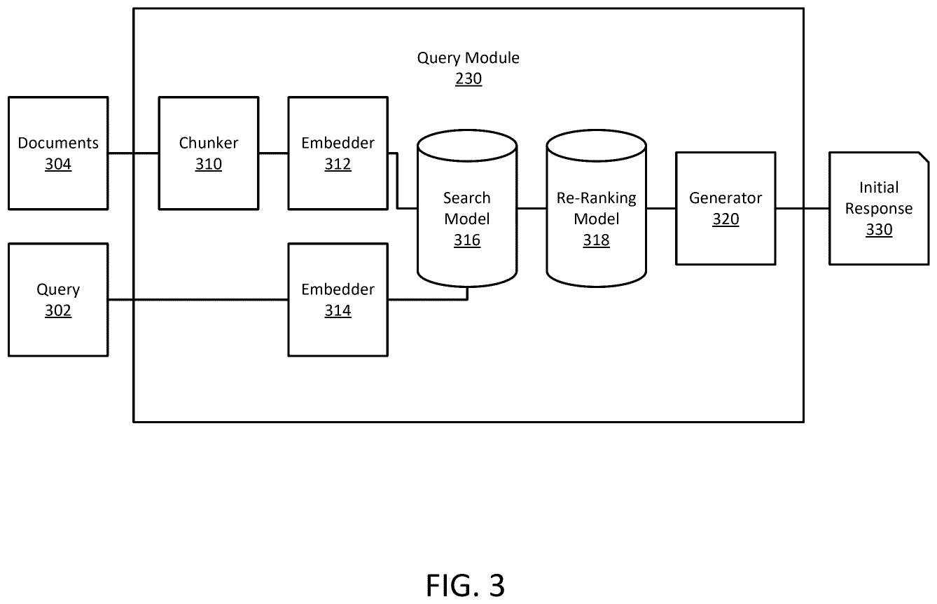

The query module 230 generates an initial response to a query. The query module 230 performs RAG to generate the initial response, as described in greater detail in relation to FIG. 3. The query module 230 interfaces with the language model 210 and the document store 220 to generate the initial response.

The conformal prediction module 240 improves the quality of the initial response by scoring sub-claims with respect to a quality (e.g., factuality, relevance, etc.) and excluding sub-claims that do not exceed a calibrated conformal threshold. By filtering (i.e., excluding or including) sub-claims based on the scores with respect to the calibrated score, the remaining sub-claims may have a calibrated confidence level for including only sub-claims that have or meet the desired quality.

The calibrated threshold uses conformal prediction (typically applied to discrete classification problems) for evaluating the quality of the sub-claims in a response, with a goal of including only sub-claims that have the scored quality. Conformal prediction is a statistical framework that transforms heuristic uncertainty estimates into calibrated confidence measures (e.g., a calibrated statistical guarantee). Conformal prediction is typically used in classification settings to provide coverage guarantees over prediction sets: after calibration, the resulting prediction set has a calibrated confidence of containing the desired model output. For example, an image classification system having classification outputs corresponding to “dog” “cat” “mouse” “rabbit” and “rat” may have classification heads corresponding to each possible output class that outputs a respective prediction. However, training and application of these classifications often do not consider the likelihood that either multiple or no classes score relatively high by the respective classification heads. In conformal prediction for classification, a prediction set for particular input image may include “mouse” and “rat” which indicates that the correct classification is one of the classes in the prediction set (mouse or rat) at the calibrated confidence level.

In typical application of conformal prediction, fewer members in the prediction set can indicate higher confidence (e.g., a single-class prediction set), while additional members may indicate lower confidence (e.g., multiple-class prediction set). Formally, for a prediction task with possible outputs Y, given a conformity measure S and a tolerable error level α, the conformal prediction set for a new example xₜₑₛₜ is:

$${C}_{\hat{q}} ( {x}_{test} ) = \{ y ∈ Y \vert S ( {x}_{test} , y ) \leq \hat{q} \} \qquad Equation 1$$

where \hat{q} is the

$$\frac{⌈ ( n + 1 ) ( 1 - α ) ⌉}{n}$$

quantile of scores S over a calibration data set containing n datapoints. When calibration and test data are drawn independent and identically distributed from a distribution [symbol] , conformal prediction guarantees marginal coverage:

$$ℙ ( {y}_{test}^{*} ∈ {C}_{\hat{q}} ( {x}_{test} ) ) \geq 1 - α \qquad Equation 2$$

In classification tasks where Y is a finite label set, conformal prediction is straightforward to apply. However, in generative settings like open-ended query-answering, the output space is effectively infinite, with many semantically equivalent responses, such that typical conformal application is not straightforward and there is not a direct classification label to use.

To use conformal prediction with RAG systems and evaluation of a particular quality (i.e., characteristic) of sub-claims, rather than use classification head scores, the conformal prediction set is constructed from the sub-claims based on scoring of the evaluated quality, such that the prediction set retains (from all sub-claims in a response) only sub-claims expected to have the quality based on the scoring and calibrated conformal threshold. An output query response y is scored with respect to the quality using a measure (which may be correlated with the quality but with potential error) and the conformal prediction enables calibration of the model's confidence about the quality (e.g., factuality) based on the scoring as also discussed further below.

Formally, in one example embodiment, for long-form query responses y with multiple sub-claims, the quality can be estimated per sub-claim, filtering out low-confidence ones based on a calibrated threshold \hat{q}, while ensuring retained sub-claims meet a quality guarantee:

$$ℙ ( {y}_{test}^{*} ⇒ {y}_{test} ( {x}_{test} ; \hat{q} ) ) \geq 1 - α \qquad Equation 3$$

The conformal prediction module 240 uses a combination of conformal prediction at the sub-claim level and document context in scoring the quality to offer statistical guarantees of response quality. Using scoring based on relevant documents helps maintain response quality by relating subclaim scoring to support in the documents, avoiding excess reduction in response length that may occur with other conformal approaches. Additionally, sub-claim level conformal prediction assessments enable retention of as many sub-claims as possible for a given calibrated threshold \hat{q}. Accordingly, query responses output by the conformal prediction module 240 have improved quantity and quality of information as compared to existing language model methods.

The conformal prediction module 240 receives an initial response generated by the query module 230 and splits the initial response into a plurality of sub-claims. Each sub-claim of the plurality of sub-claims is scored by the conformal prediction module 240, the score being correlated with a quality (e.g., factuality, relevance, toxicity, etc.). The scoring of a sub-claim involves comparison of the sub-claim to the initial query, the retrieved documents, or both, according to some embodiments. The conformal prediction module 240 determines a validated set of sub-claims using a calibrated threshold \hat{q}, which provides a statistical guarantee of the quality.

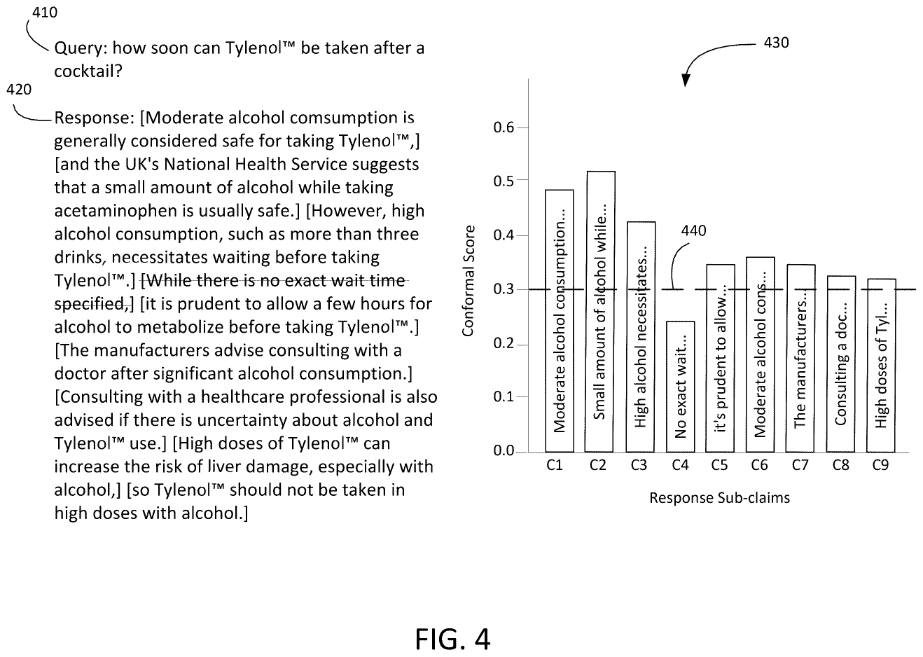

The calibrated threshold \hat{q} is determined by the conformal calibration module 250 and stored in the calibration data store 260, as discussed below. The splitting, scoring, and validation of sub-claims by the conformal prediction module 240 is discussed in greater detail in the illustrative example of FIG. 4.

A filtered response that includes the validated set of sub-claims is generated by the conformal prediction module 240. The filtered response generated by the conformal prediction module 240 differs from the initial response generated by the query module 230, wherein the filtered response has a statistical guarantee of quality. The initial response does not have a statistical guarantee of quality and may include sub-claims without the desired quality, such as unverifiable information (e.g., unsupported by any retrieved documents), irrelevant information (not responsive to the original query), improper tone or otherwise toxic language, or other poor-quality inclusions.

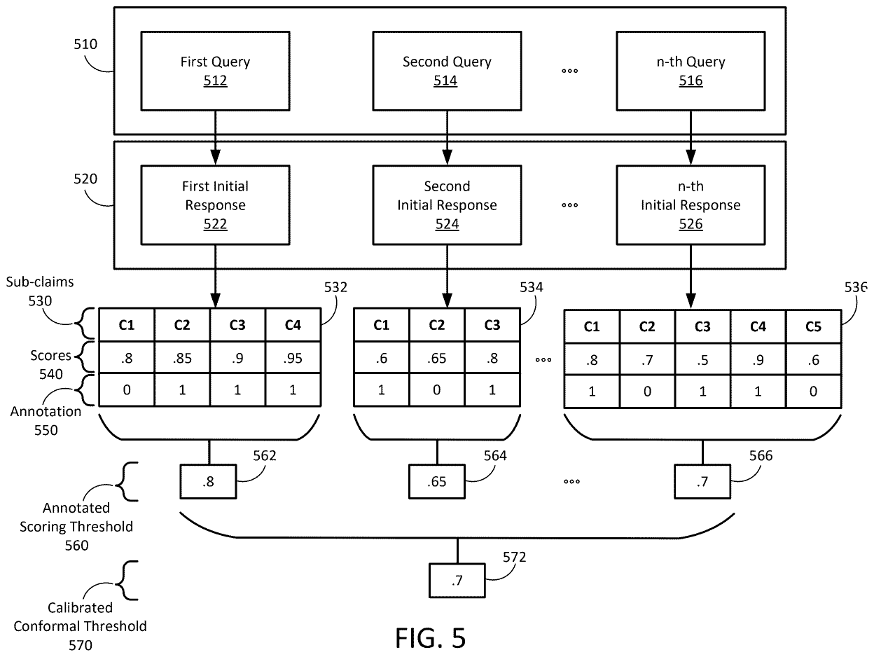

The conformal calibration module 250 determines one or more calibrated thresholds, \hat{q}, for use by the calibrated query response system 130 (specifically by the conformal prediction module 240). The process of determining a calibrated threshold, \hat{q}, is described in greater detail in relation to FIG. 5. The conformal calibration module 250 reads data from and writes data to the calibration data store 260.

The calibration data store 260 stores the one or more calibrated thresholds \hat{q} and other data related thereto. The calibration data store 260 stores labeled data, such as ground-truths y*, for use by the conformal calibration module 250 in determining the one or more calibrated thresholds q. According to some examples, the calibration data store 260 also stores queries x and query responses y that are annotated (labeled) with the ground-truths y* to determine the one or more calibrated thresholds q. The calibration data store 260 uses computer-readable media to store data and may use databases to organize the stored data.

FIG. 3 is an example pipeline for generating an initial response by a retrieval-augmented generation (RAG) system, according to one or more embodiments. In one embodiment, the initial query is processed by a RAG system by the query module 230 and may include respective use of a language model 210 and document store 220. RAG systems enable incorporating information from additional documents (e.g., from document store 220) when responding to a query and may be particularly useful to incorporate data/documents that did not form part of the training data for the language model 210. The additional information in the document store 220 may then be used to provide additional information as context for the language model to generate outputs using relevant documents from the document store 220. Ideally, RAG systems may improve reliability of generated text by grounding generation in factual information to reduce fabricated content and may also be particularly useful when non-public domain knowledge is required. Although RAG systems are prone to fewer errors (e.g., hallucinations) than language models that do not use additional document context, these systems may still generate responses that (at least partially) fail to meet desired standards for factuality and for other types of qualities as discussed above.

The example query module 230 is one example of a pipeline that may be used for RAG systems; additional architectures and layers may be used in other embodiments. The query module 230 comprises a chunker 310 and embedders 312, 314 to provide pre-search language processing, a search model 316 and re-ranking model 318 determine the most-relevant document chunks with respect to the query, and a generator 320 that converts the most-relevant chunks into an initial response 330. This functionality may be distributed differently among these sub-system components in different embodiments.

The query module 230 receives a query 302 and documents 304. The query module 230 generates an initial response 330 in response to the query 302 using the documents 304 as context for generating the initial response 330. The query module 230 interacts with a language model (such as the language model 210) to generate the initial response 330. The documents 304 provide context that effectively supplement the language model's 210 pre-existing training data.

The query 302 is a question or an information-seeking statement for which a response is expected to be returned. The information being sought by the query 302 sets the scope of the query response. The query 302 can be user-generated, system-generated, or language model-generated.

The documents 304 are substantive texts or other data providing relevant context within the scope of the query 302. For a given query, the query module 230 retrieves a set of m relevant documents D={d₁, d₂, . . . dₘ} from the document store 220.

The chunker 310 processes each document of the documents 304 by parsing the text into smaller units, called chunks. By processing the documents into chucks, smaller portions of the documents may be retrieved that may be most-relevant to particular queries. This may also prevent excessive inclusion of less-relevant documents in the context included for the language model. As such, the chunk may represent the unit that is retrieved and processed for particular queries. The chunker 310 may process the documents 304 using any chunking methodology, including but not limited to fixed-size chunking, sentence-based chunking, paragraph-based chunking, semantic chunking, sliding window chunking, or any combination of these approaches. In some situations, certain documents may be included without chunking (e.g., documents smaller than a maximum chunk size).

The embedder 312 encodes each chunk of the documents 304 into encoded vectors (i.e. vectorized chunks) that enables evaluation of the chunks in an encoded vector space. Similarly, the embedder 314 encodes the query 302 into a vector. The embedders 312, 314 may be the same embedding model or different embedding models. In some embodiments, the embedders 312, 314 each comprise a plurality of trained embedding models, enabling inference time use of different representation techniques, such as frequency-based embedding (e.g., TF-IDF), semantic or prediction-based embedding (e.g., Word2Vec including both CBOW and skip-gram, GloVe), transformer or contextual-based embedding (e.g., ELMo, BERTs, GPTs), among other natural-language processing techniques. Where the documents 304 include images, the embedder 312 vectorizes the images, according to some embodiments.

The search model 316 determines relevant chunks to a particular query by retrieving chunks based on the respective encodings. As one example, the encoded (vectorized) chunks may be indexed, and the retrieval may include a dense vector retrieval to identify relevant chunks based on similarity between the query encoding and the chunk encoding. The search model 316 may use any similarity algorithm in the dense vector retrieval search, such as cosine similarity or dot product similarity, to determine which vectorized chunks are most relevant to the vectorized query. The search model 316 may include a neural network trained for dense vector retrieval search, such as a dual encoder, to perform the dense retrieval search.

The re-ranking model 318 may re-order and re-evaluate the relevance of the retrieved chunks. The re-ranking model 318 may be a separate model from the search model 316. The re-ranking model 318 may be a neural network or other model type (e.g., transformer model) that has been fine-tuned to perform a deeper analysis than the search model 316. The re-ranking model 318 determines a set of top-ranked document chunks that are most semantically relevant to the query 302.

The generator 320 responds to the query 302 with the top-ranked document chunks to generate an initial response 330 to the query 302. The generator 320 is a language model that generates the initial response 330 based on a context determined from the top-ranked document chunks into an initial response 330 to the query 302 as an output. The generator 320 may be any suitable language model, such as a large language model (LLM). In some embodiments, the generator 320 is the language model 210.

Despite the merits of RAG systems, they can still be error-prone in practice. Due to the complexity of RAG pipelines and use of language models, these errors are diverse and their causes can be difficult to trace. The initial response 330 generated by query module 230 is further processed by the conformal prediction module 240 to ensure the quality to generate a response that reduces these errors by evaluating the designated quality in the response using sub-claim scoring and calibrated conformal thresholds as further discussed herein.

FIG. 4 is an example query, response, and bar graph of scored sub-claims and conformal scores, according to one or more embodiments. The conformal prediction module 240 performs the scoring of sub-claims with respect to the evaluated quality, according to some embodiments. The conformal prediction module 240 receives a query 410 and a response 420 to the query, for example, from the query module 230. The query 410 may be an example of the query 302. The response 420 is typically a RAG-generated response, such as the initial response 330. The conformal prediction module 240 identifies sub-claims within the initial response 420 and scores the sub-claims with respect to the desired quality. In some embodiments, the evaluated response and scoring of sub-claims may be performed with respect to responses 420 generated by other means.

Initially, the response 420 is split into a plurality of sub-claims for scoring and analysis. In this example, the response 420 is split into 9 subclaims labeled {C1, C2, . . . , C9} in this example. The designation of each sub-claim {C1, C2, . . . , C9} within the response 420 is depicted in FIG. 4 with brackets [ ]. By separating the response 420 into component sub-claims, the evaluation of the response can proceed with respect to individual aspects of the response. In this way, the response can be revised by identifying particular aspects of the response (i.e., sub-claims) that are unlikely to have the required quality and removing those portions, while maintaining portions that do have the required quality. In the example of FIG. 4, this permits identification and removal of the sub-claim “While there is no exact wait time specified,” when evaluated for the quality of factuality while maintaining other sub-claims of the response 420.

Each sub-claim is a portion of the response 420 containing a concept, assertion, or other type of statement that is separable from the other sub-claims of the response 420. Splitting the response 420 into sub-claims {C1, C2, . . . , C9} is performed by any of various splitting methodologies, such as splitting sentence-by-sentence (or other punctuation), or splitting by semantic meaning. For example, when split by semantic meaning, each sub-claim contains a respective semantic meaning independent from the other sub-claims, such that each sub-claim relates to a distinct concept or statement.

Splitting an initial response into sub-claims can be implemented using various text processing systems, which may include one or more natural-language processing systems, e.g., LLMs, BERTs. For example, the response 420 provided to a language model tasked with splitting the response 420 into discrete independent sub-claims. In additional examples, the splitting may be performed by additional or alternate natural-language or text processing, for example to separate clauses, sentences, paragraphs, or other portions of the initial response, which may be performed alone or in combination with language model processing for the sub-claims. In various implementations, the initial response may be split by the language model 210, the query module 230, the conformal prediction module 240, or another part of the calibrated query response system 130.

The conformal prediction module 240 computes a score for each sub-claim, for example, using a scoring function. The score of each respective sub-claim for the example of FIG. 4 is illustrated in a bar graph 430. The scoring function quantifies how well a sub-claim is associated with the quality. For the quality of “factuality,” the scoring function aims to evaluate how well the sub-claim is supported, “follows from,” or is entailed by relevant documents (e.g., retrieved documents for the query in the RAG process). For the quality of “relevance,” the scoring function aims to evaluate how well the sub-claim is related to the query 410. For additional types of qualities, the sub-claims may be similar scored for the related qualities. For example, tone and/or toxicity may be scored by evaluating sub-claims against a dictionary or set of model phrases or examples to determine similarity with the respective sub-claim. In some examples, the scoring function may compute one or more sub-scores for each of the sub-claims and determine an overall sub-claim score based on the sub-scores.

As one embodiment for evaluating factuality, the factuality for a sub-claim may be scored by evaluating the sub-claim against the set of retrieved documents for the query and scoring the sub-claim based on the support for the sub-claim in the “best” retrieved document. That is, the sub-claim may be considered factual based on the highest-scoring support among the relevant documents.

More formally, in one embodiment, given a query x∈X, the calibrated query response system 130 retrieves a set of m relevant documents D={d₁, d₂, . . . , dₘ} from the document store 220. The query module 230 generates an initial response ŷ, which is composed of p sub-claims ŷ={c₁, c₂, . . . , cₚ}. The conformal prediction module 240 in this embodiment generates a score r for each of p sub-claims ŷ={c₁, c₂, . . . , cₚ} using an example scoring function that evaluates qualities of factuality (of the sub-claim to the document) and relevance (of the document to the query):

```
Algorithm 1
Function, R(c):
    for cₖ ∈ ŷ do
        for dⱼ ∈ D do
            sₖ_{ⱼ} = CosineSimilarity(x, dⱼ) · CosineSimilarity(cₖ, dⱼ)
        end for
        ${r}_{k} = max ( {\{ {s}_{{k}_{j}} \}}_{j = 1}^{m} ⋃ 0 )$
    end for
    $return {\{ {r}_{k} \}}_{k = 1}^{p}$
```

In this example scoring function, the score, rₖ associated with a sub-claim cₖ is computed as the maximum sub-score sₖ_{ⱼ} across all documents dⱼ∈D. For each document dⱼ and the sub-score sₖ_{ⱼ} is a combination of the relevance of the sub-claim to the query and the factuality of the sub-claim to the document as determined with their respective vector representations. Particularly, the sub-claim to document sub-score in this scoring function is a dot product of a) a cosine similarity of query x with the document dⱼ (CosineSimilarity (x, dⱼ)) with b) a cosine similarity of the sub-claim cₖ with the document dⱼ (CosineSimilarity (cₖ, dⱼ)). The scores r={r₁, r₂, . . . , rₚ} associated with each respective sub-claim ŷ={c₁, c₂, . . . , cₚ} provide an approximate quantification of how well each respective sub-claim ŷ={c₁, c₂, . . . , cₚ} is entailed or otherwise supported by the documents D={d₁, d₂, . . . , dₘ}.

Various embodiments may use alternate scoring functions for measuring a quality of a sub-claim. In some embodiments, the scoring function includes taking a mean of sub-score values across all relevant documents (e.g., retrieved documents and/or documents used as context for the query). Additionally, or alternatively, the scoring function may determine how frequently documents support a sub-claim.

In some embodiments, the query module 230 generates multiple initial responses 330, and the scoring function is a frequency scoring that aggregates how frequently a sub-claim appears across the multiple responses. More frequent appearances of a sub-claim across different responses may indicate the sub-claim is both more relevant and more likely to be factual (e.g., the same hallucination rarely happens multiple times).

A bar graph 430 provides a visual representation of the respective score of each sub-claim {C1, C2, . . . , C9}. The bar graph 430 also includes a visual representation of a calibrated conformal threshold 440. The conformal prediction module 240 determines a set of validated sub-claims by comparing the respective score of each sub-claim {C1, C2, . . . , C9} to the calibrated conformal threshold 440.

The conformal prediction module 240 excludes sub-claims having a score at or below the calibrated conformal threshold 440 from the set of validated sub-claims, and likewise from the resultant filtered response. For example, sub-claim C4 (“While there is no exact wait time specified,”) has a respective score that is below the calibrated conformal threshold 440. The conformal prediction module 240 excludes C4 from the response 420, as indicated by the strikethrough text of C4. As such, the value of the conformal threshold 440 determines which sub-claims are considered sufficiently likely to have the desired quality.

Sub-claims having a score above the calibrated conformal threshold 440 are “validated” for inclusion in a filtered response generated by the calibrated query response system 130. The resultant filtered response has a statistical guarantee (e.g., confidence level) of the quality because of the calibration of the conformal threshold 440.

In examples where the calibrated conformal threshold 440 is different, the sub-claims that are excluded may vary. A higher conformal threshold 440 may be set to provide a higher confidence of the quality, but may also exclude additional sub-claims. For example, a confidence level that sets the calibrated conformal threshold 440 higher, to 0.4, would result in sub-claims C5, C6, C7, C8, and C9 being excluded in addition to the exclusion of C4. The resulting filtered response would be shorter (i.e., comprising fewer sub-claims) but have a higher confidence in factuality commensurate with the higher confidence level used in calibrating the higher threshold.

As can be seen in FIG. 4, different values of the threshold 440 may include or exclude different sub-claims. In many cases, the scoring process may have some unreliability and/or variance, such that values of the conformal scores are expected to correlate with the evaluated quality while individual scores for particular sub-claims may not correctly reflect known labels (e.g., when evaluated against a known training data set). As an example, for a quality of factuality, where higher scores are expected to indicate higher likelihood of factual support, it is possible that a sub-claim conformal score of 25 may be “true” while a higher conformal score of 0.28 may be “false” (for known factual labels).

The conformal threshold 440 may thus be set to a calibrated value with a given confidence level as discussed below to calibrate the likelihood of including sub-claims without the desired quality while maintaining the greatest number of sub-claims for a “more complete” response. As shown in FIG. 4, higher values of the threshold 440 may exclude additional sub-claims, increasing the likelihood that all remaining sub-claims maintain the desired quality, but at the cost of reducing the completeness of the response 420 (i.e., because portions of the response 420 may be removed). The calibration of the calibrated conformal threshold is discussed further with respect to FIG. 5.

Then, the conformal prediction module 240 removes each sub-claim with an associated score below the calibrated conformal threshold 440 from the response 420 to generate a filtered response that contains only sub-claims with scores above the threshold 440. Because the threshold 440 is calibrated with respect to a confidence level, the filtered response having sub-claims above the threshold 440 has a statistical guarantee related to the evaluated quality. In this illustrative example, the filtered response generated from the initial response has a statistical guarantee of factuality. As there is inherent uncertainty for the scoring with respect to the quality, there is inherent uncertainty in evaluating the scores with respect to the threshold. However, by calibrating the threshold with respect to a level of confidence, the threshold may “guarantee” the quality at the designated confidence level. E.g., a calibrated threshold for a confidence level of 90% may indicate that, by excluding sub-claims having scores below the threshold, the resulting responses have a 90% confidence of having no sub-claims lacking the quality. The remaining sub-claims may then be used to generate the filtered response for the query.

FIG. 5 shows generating a calibrated conformal threshold 570 from calibration data, according to one or more embodiments. The calibrated conformal threshold 570 is determined by the conformal calibration module 250 based on calibration data stored in the calibration data store 260. In the example of FIG. 5, the evaluated quality is factuality; as discussed above, additional qualities may be similarly evaluated, such as relevance, tone, toxicity, etc.

The calibration data comprises a set of calibration queries 510 and a set of ground-truths associated with the calibration queries 510. An initial response 520 is generated in response to each respective calibration query 510 through a RAG process (e.g., by the query module 230). Each respective initial response 520 is split into sub-claims 530 and each sub-claim is given a score 540 using a scoring function (e.g., by the conformal prediction module 240). The set of ground-truths are used to automatically annotate (e.g., label) each sub-claim 530 as factual or non-factual in a binary annotation 550, as discussed further below.

The conformal calibration module 250 determines, for each calibration query 510, an annotated scoring threshold 560 representing a cutoff score that excludes all sub-claims that have been non-positively annotated (e.g., annotated as non-factual). The calibrated conformal threshold 570 is determined from quantiles of the set of annotated scoring thresholds 560 with respect to a particular error tolerance α. The resulting calibrated conformal threshold 570 is used by the calibrated query response system 130 to provide statistical guarantees of factuality in query-answering tasks.

Each of the calibration queries 510, the initial responses 520, the sub-claims 530, the scores 540, the annotations 550, the annotated scoring thresholds 560, and the calibrated conformal threshold 570 may be stored, temporarily or persistently, in the calibration data store 260.

The set of calibration queries 510 includes a plurality of calibration queries, for example, there are N calibration queries, where N can be any integer: first query 512, second query 514, . . . , n-th query 516. The calibration queries 510 are stored in the calibration data store 260. The calibration queries 510 may be human-generated data or system-generated data. The calibration queries 510 can be considered training data for the calibrated query response system 130.

The set of initial responses 520 includes a plurality of RAG-generated responses. An initial response 520 is generated for each respective calibration query 510, for example, by the query module 230. In the illustrative example of FIG. 5, a first initial response 522 is generated in response to the first query 512, a second initial response 524 is generated in response to the second query 514, . . . , and an n-th initial response 526 is generated in response to the n-th query 516.

Each initial response 520 is split into a plurality of sub-claims 530, for example, by the conformal prediction module 240. Generally, for each query x in the set of calibration queries 510, the RAG-generated initial response 520 is represented as ŷ={c₁, c₂, . . . , cₚ}, where p indicates the number of separable sub-claims in the initial response 520. For example, the first initial response 522 is split into p=4 sub-claims 532, {C1, C2, C3, C4}, the second initial response 524 is split into p=3 sub-claims 534, {C1, C2, C3}, and the n-th initial response 526 is split into p=5 sub-claims 536, {C1, C2, C3, C4, C5}.

A score 540 is computed for each sub-claim 530 using a scoring function, for example, by the conformal prediction module 240. Generally, the scoring function, R(c∈ŷ) assigns each sub-claim c a score, for example, as shown in Algorithm 1. The score R(c) quantifies the sub-claim c with respect to the quality. For example, for factuality, the score may evaluate the sub-claim c with respect to its respective calibration query x and documents D retrieved during RAG to generate the respective initial response ŷ. For example, with respect to the sub-claims 530 associated with the first initial response 522, sub-claim C4 having a score of 0.95 is expected to be more likely to be factual than sub-claim C1 having a score of 0.8.

In addition to quantifying entailment via the scores 540, for each sub-claim 530, the conformal calibration module 250 identifies associated annotations 550 (i.e., labels) for each sub-claim.

The annotations 550 provide a binary indication of whether each respective sub-claim 530 is supported by labeled ground-truth responses. In some embodiments, the annotations may be performed by manual human review. In additional embodiments, the conformal calibration module 250 automatically annotates each sub-claim 530 using an annotation process. Typically, the automated annotation process may be expected to have a greater evaluative ability than the scoring function for the quality, but may do so with additional drawbacks, such as increased processing requirements, use of more complex models, additional runtime, or requires resources beyond those used in the scoring function. Generally, for an annotatable sub-claim c, a calibration query x, a RAG-generated initial response ŷ, a labeled ground-truth response y*, and one or more documents D, the annotation function A(c∈ŷ, x, y*, D)=1 when the sub-claim 530 is factual, and the annotation function A(c∈ŷ, x, y*, D)=0 when the sub-claim 530 is non-factual (e.g., false, or not enough information to support it).

The annotation function A(c∈ŷ, x, y*, D) can be implemented, for example, using an LLM (e.g., language model 210). The LLM is prompted to judge the factuality of the sub-claim c based on being provided the sub-claim c, the calibration query x, the RAG-generated initial response ŷ, the labeled ground-truth response y*, and the one or more documents D.

An annotated scoring threshold 560 is computed for each calibration query 510 using the set of scores 540 and annotations 550 associated with the particular calibration query 510. The annotated scoring threshold 560 represents the smallest score 540 that excludes all sub-claims 530 that have been non-positively annotated (e.g., having annotation 550 of zero).

Formally, each annotated scoring threshold is determined by the conformal calibration module 250 using a filtering function F_{q}({c}) with threshold q acting on a set of sub-claims {c}. As the threshold q increases from 0, filtering function Fa progressively filters out more of the sub-claims in the set of sub-claims {c}. In some examples, the filtering function F_{q} is constructed using the scoring function R(c):

$${F}_{q} ( \hat{y} ) = \{ c ∈ \hat{y} \vert R ( c ) \geq q \} \qquad Equation 4$$

To determine the appropriate annotated scoring threshold, S, conformal prediction calibration is used over the scores, R(c):

$$S ( {x}_{i} , {y}_{i}^{*} ) := inf \{ q ∈ {ℝ}^{+} \vert ∀ {q}^{′} \geq q , ∀ c ∈ {F}_{{q}^{′}} ( {\hat{y}}_{i} ) , A ( c , {x}_{i} , {y}_{i}^{*} , D ) = 1 \} \qquad Equation 5$$

That is, the annotated scoring threshold, S, is the smallest threshold q, such that all retained sub-claims are positively annotated by the annotation function, A. In the example of FIG. 5, the annotated scoring threshold 560, S, for each calibration query 510 is the smallest threshold q, such that all retained sub-claims are considered to have the quality (e.g., factuality) by the annotation function, A.

To determine the overall calibrated conformal threshold 570, annotated scoring thresholds 560 are thus determined for each of the annotated query-response pairs. These annotated scoring thresholds 560 may differ for different sets of sub-claims. The calibrated conformal threshold 570 may then be determined as a threshold value for which a desired proportion (e.g., as a percentile) of responses, if filtered by the calibrated threshold, would retain only the desired sub-claims.

For example, for sub-claims 532 associated with the first initial response 522 to the first query 512, the sub-claims {C2, C3, C4} are positively annotated (factual) and the sub-claim {C1} is non-positively annotated (non-factual). In this example, the smallest threshold q that retains only positively-annotated claims of the first initial response 522 is based on the associated scores 540 (e.g., R(c)) associated with the non-positively annotated sub-claim {C1} of 0.8. That is, the first annotated scoring threshold 562, S₁, is 0.8 based on the score 540 for non-factual subclaim C1 of sub-claims 530 for the first initial response 522. Stated another way, using the annotated scoring threshold 562 to remove sub-claims 530 having scores 540 below the threshold would remove all non-factual sub-claims and retain sub-claims {C2, C3, C4}.

For the second query-response pair in this example, for sub-claims 534, {C1, C2, C3}, associated with the second initial response 524 for the second query 514, the sub-claims {C1, C3} have positive annotations (factual) and the sub-claim {C2} has a non-positive annotation (non-factual). The smallest threshold q to retain only positively annotated sub-claims, in this example, is 0.65. That is, the second annotated scoring threshold 564, S₂, is 0.65.

In this second example for sub-claims 534, using q=0.65 as the annotated scoring threshold 560 would retain only sub-claim {C3}. Although positively annotated, sub-claim {C1} would be excluded from the filtered response, F_{q}(ŷ), even though it is annotated positively because the score 540 associated with {C1} of 0.6 is less than the second annotated scoring threshold 564, q=S₂=0.65. As discussed above, the scoring function may present inherent uncertainty, such that in some cases, as here, a sub-claim having the quality (annotated positively) may have a lower score than a sub-claim without the quality (annotated negatively). As such, to obtain an annotated scoring threshold 564 for the sub-claims 534 that excludes all negative annotations, a positively-annotated sub-claim is also excluded in this example.

In an additional example, sub-claims 536 {C1, C2, C3, C4, C5} are associated with the n-th initial response 526 to the n-th query 516; the sub-claims {C1, C3, C4} are positively annotated (factual) and the sub-claims {C2, C5} are non-positively annotated (non-factual). In this example, though both {C2, C5} are non-positively annotated, the score 540 associated with {C2} of 0.7 is greater than {C5} of 0.6. Accordingly, the smallest threshold q to retain only positively annotated sub-claims, in this example, is 0.7. The n-th annotated scoring threshold 566, is 0.7. For sub-claims 536, using q=0.7 as the threshold would include the sub-claims {C1, C4}.

As shown in these examples of FIG. 5, different values of annotated scoring thresholds 560 are associated with the different sets of sub-claims. Although the annotated scoring threshold 560 for a particular set of sub-claims may filter all negatively-annotated sub-claims for that set of sub-claims, applying that threshold to other sets of sub-claims may under- or over-filter sub-claims. To determine a calibrated conformal threshold 570 that may be applied to initial responses with unknown annotations, the calibrated conformal threshold 570 is determined based on the annotated scoring thresholds 560.

If, for example, a threshold of 0.65 (associated with annotated scoring threshold 560) were used for the first set of sub-claims 532, this threshold value would fail to exclude all non-positively annotated sub-claims. However, reversing this example, applying the annotated scoring threshold 562 of 0.8 (associated with the first set of sub-claims) to the second set of sub-claims would remove all sub-claims 534. Thus, the inherent uncertainty in the scoring function for the qualities and applying related thresholds can fail to filter out all the non-factual (or other non-quality) sub-claims in a generated response or can excessively filter sub-claims that should be retained.

To set an appropriate threshold with an expected confidence level for the quality (e.g., factuality) when filtering sub-claims, a calibrated conformal threshold 570 is determined based on the annotated scoring thresholds 560. The calibrated conformal threshold 570, \hat{q}, is set as the

$$\frac{⌈ ( n + 1 ) ( 1 - α ) ⌉}{n}$$

quantile of the annotated scoring threshold over the calibration set of size n, where a represents the error tolerance. The error tolerance may thus provide a confidence level for the percentile of processed responses expected to be free of sub-claims without the scored quality. The calibrated conformal threshold 570, \hat{q}, accordingly provides a statistical guarantee of factuality (or another quality) based on the calibration set and error tolerance, α.

When processing initial responses, the calibrated query response system 130 filters out sub-claims with scores (e.g., R(c)) less than the calibrated conformal threshold 570, \hat{q}, and the calibrated query response system 130 returns validated sub-claims yₜₑₛₜ=F_{\hat{q}}(ŷ). This approach permits application of the scoring function, which in various embodiments includes evaluation against the documents and/or the query, for calibrated sub-claim evaluation.

In some instances, certain groups within a data set may be over or under covered when conformal prediction does not account for the group data. To address this, group-conditional coverage can applied by determining conformal thresholds for each group based on a pre-specified grouping among a number of groups g such that the overall data is identifiable by individual groups: X→G={1 . . . n_{g}}:

$$ℙ ( {y}_{test}^{*} ∈ {C}_{{\hat{q}}_{a}} ( {x}_{test} ) \vert g ( {x}_{test} ) = a ) \geq 1 - α , ∀ a ∈ G \qquad Equation 6$$

Correspondingly, the calibrated conformal threshold, \hat{q}ₐ, may be determined for each group attribute a (e.g. topic category or difficulty of the query).

The calibrated query response system 130 first partitions the calibration data by groups using g, then calibrates a distinct calibrated conformal threshold, \hat{q}ₐ, for each a∈G using the calibration described above. Then, when evaluating initial responses, the group for the initial response is determined and the calibrated conformal threshold, \hat{q}ₐ, for group aₜₑₛₜ=g(xₜₑₛₜ) is used for filtering out claims to return yₜₑₛₜ=F_{\hat{q}}_{ₜₑₛₜ}(ŷ)

As discussed, the calibrated conformal threshold, \hat{q}, is used to filter out non-quality sub-claims to generate a filtered response with a statistical guarantee of the quality (e.g., factuality). By calibrating the threshold to determine the smallest threshold q to retain only positively annotated sub-claims, the resulting filtered responses can be longer and more informative while providing a statistical guarantee of factuality. Particularly, this improves generated responses from language models and RAG systems by reducing undesirable qualities that may otherwise be difficult to determine or detect given the generative nature of these systems, and to do so without excess caution (e.g., without excising more sub-claims than required to maintain the desired confidence level for the quality).

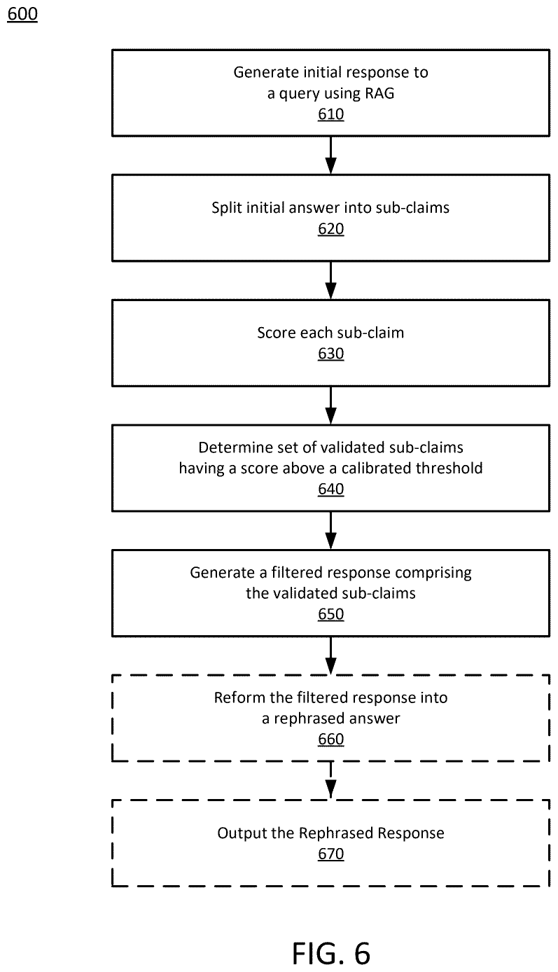

FIG. 6 is a flow diagram 600 of a method for generating a response using the calibrated query response system 130 at inference time, according to one or more embodiments. The calibrated query response system 130 receives a query at inference time, for example, over the network 120.

The calibrated query response system 130 generates 610 an initial response to the query using RAG. In some examples, the query module 230 generates 610 the initial response using RAG and accesses the language model 210 and the document store 220 as needed. The RAG process, for example, by the query module 230, identifies a set of documents relevant to the query and applies the query to the set of documents. The initial response can be generated 610 through a pipeline similar to FIG. 3.

The calibrated query response system 130 splits 620 the initial response into sub-claims. In some examples, the conformal prediction module 240 splits 620 the initial response into a plurality of sub-claims and accesses the language model 210 as needed to split the sub-claims. In some embodiments, the initial response is split into sub-claims based on semantic meaning, where each sub-claim has a respective semantic meaning that is independent from the other sub-claims. The initial response can be split 620 into sub-claims by any other methodology described in relation to FIG. 4.

The calibrated query response system 130 scores 630 each sub-claim. The score of each sub-claim is correlated to a quality, such as factuality, relevance, or non-toxicity of language, etc. The sub-claims are scored 630 using a scoring function, such as the examples discussed above. In some examples, the scoring function scores a sub-score with respect to each document in the set of documents and determines the overall score for the respective sub-claim based on the sub-scores. For example, the overall score can be the maximum of the sub-scores. As discussed above, while the scoring function is expected to generally correlate with the quality, the scoring function is probabilistic. As such, while typically a “higher” scoring sub-claim may be more likely to have the quality and “lower” scoring sub-claims less likely to have the quality, there may be situations where relatively higher-scoring sub-claims do not have the quality and relatively lower-scoring subclaims do have the quality.

In some embodiments, each sub-claim is scored 630 based on computing, for each document in the set of documents, the sub-score based on a combination of a query-document score and a sub-claim document score. In some examples, cosine similarity is used to determine the query-document score and the sub-claim document score.

In additional or alternative embodiments, each sub-claim may be scored 630 using RAG with the set of documents to generate multiple initial responses. For each sub-claim in the multiple initial responses, the scoring function aggregates how frequently the respective sub-claim appears across the multiple initial responses and scores the sub-claim based on the aggregated frequency.

The calibrated query response system 130 determines 640 a set of validated sub-claims each having a score above a calibrated threshold, \hat{q}. The calibrated threshold provides a statistical guarantee of the quality (e.g., factuality, relevance, or non-toxicity of language, etc.) in the validated set of sub-claims. In some examples, the calibrated threshold is the calibrated conformal threshold 570 determined by the conformal calibration module 250 and stored in the calibration data store 260. Additionally, or alternatively, the calibrated threshold is calibrated based on group attributes and may be one of a plurality of distinct calibrated conformal threshold, \hat{q}ₐ, for each a∈G.

The calibrated threshold is determined using any methodology discussed. In some examples, the calibrated threshold is determined based on quantiles representing statistical guarantees for excluding all non-positively annotated sub-claims from a set of annotated sub-claims. The annotations are a binary representation of a quality (e.g., 1 for factual, 0 for non-factual). The annotations for each annotated sub-claim in some embodiments are generated by a language model, e.g., an LLM. In some examples, the annotation is automatically generated for an annotatable sub-claim by providing the annotatable sub-claim, a calibration-stage query, a generated response to the calibration-stage query (e.g., RAG-generated), and one or more documents to a language model. The language model processes an annotation function with these data sets to determine the annotation for the annotatable sub-claim.

The calibrated query response system 130 generates 650 a filtered response comprising the validated sub-claims. The filtered response does not include any of the sub-claims that were filtered out by applying the calibrated threshold. The validated sub-claims in the filtered response have statistically guaranteed confidence levels for the quality (e.g., factuality, relevance, or non-toxicity of language, etc.).

In some embodiments, the calibrated query response system 130 reforms 660 the filtered response into a rephrased response. The removal of certain sub-claims to generate the filtered response may affect the grammatical structure of the overall response. In some examples, the filtered response may not make sense to an end-user. The reforming 660 of the filtered response is performed by a LLM, which is prompted to merge them into a coherent response that becomes the rephrased response. In some examples, the reforming 660 is done by the language model 210.

In some embodiments, the calibrated query response system 130 outputs 670 the rephrased response. The calibrated query response system 130 may output 670 the rephrased response over the network 120. In some embodiments, the rephrased response is output 670 to be presented for display via a UI on a client device 116.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for retrieval-augmented generation with a calibrated quality guarantee, comprising:
a processor configured to execute instructions; and
a computer-readable medium having instructions executable by the processor for:
generating an initial response by applying a query to a model using retrieval-augmented generation that identifies a set of documents relevant to the query and applies the query to the set of documents;
splitting the initial response into a plurality of sub-claims;
scoring each sub-claim of the plurality of sub-claims, the score of each sub-claim being correlated with a quality;
determining a set of validated sub-claims by selecting sub-claims from the plurality of sub-claims having a score above a calibrated threshold, the calibrated threshold providing a statistical guarantee of the quality in the set of validated sub-claims; and
generating a filtered response comprising the set of validated sub-claims.

2. The system of claim 1, wherein the instructions are further executable for:
determining the calibrated threshold based on quantiles representing statistical guarantees for excluding all non-positively annotated sub-claims from a set of annotated sub-claims.

3. The system of claim 2, wherein determining the calibrated threshold further comprises:
automatically generating an annotation for an annotatable sub-claim by providing the annotatable sub-claim, a calibration-stage query, a generated response to the calibration-stage query, and one or more documents to a language model; and
processing, by the language model, an annotation function.

4. The system of claim 1, wherein the quality is factuality.

5. The system of claim 1, wherein the instructions are further executable for:
reforming the filtered response with respect to the query using a large language model (LLM) to rephrase the filtered response into a rephrased response; and
outputting the rephrased response.

6. The system of claim 1, wherein the instructions for scoring a respective sub-claim of the plurality of sub-claims further comprises:
scoring a sub-score with respect to each document in the set of documents; and
determining the score of the respective sub-claim is based on the sub-scores.

7. The system of claim 6, wherein the instructions for scoring the respective sub-claim of the plurality of sub-claims further comprises:
computing, for each document in the set of documents, the sub-score based on a combination of a query-document score and a sub-claim-document score.

8. The system of claim 1, wherein the instructions are further executable for:
generating multiple responses using retrieval-augmented generation with the set of documents; and
for each respective sub-claim of the plurality of sub-claims:
aggregating how frequently the respective sub-claim appears across the multiple responses; and
scoring the respective sub-claim based on the aggregate frequency.

9. A method for retrieval-augmented generation with a calibrated quality guarantee, comprising:
generating an initial response by applying a query to a model using retrieval-augmented generation that identifies a set of documents relevant to the query and applies the query to the set of documents;
splitting the initial response into a plurality of sub-claims;
scoring each sub-claim of the plurality of sub-claims, the score of each sub-claim being correlated with a quality;
determining a set of validated sub-claims by selecting sub-claims from the plurality of sub-claims having a score above a calibrated threshold, the calibrated threshold providing a statistical guarantee of the quality in the set of validated sub-claims; and
generating a filtered response comprising the set of validated sub-claims.

10. The method of claim 9, further comprising:
determining the calibrated threshold based on quantiles representing statistical guarantees for excluding all non-positively annotated sub-claims from a set of annotated sub-claims.

11. The method of claim 10, wherein the method for determining the calibrated threshold further comprises:
automatically generating an annotation for an annotatable sub-claim by providing the annotatable sub-claim, a calibration-stage query, a generated response to the calibration-stage query, and one or more documents to a language model; and
processing, by the language model, an annotation function.

12. The method of claim 9, wherein the quality is factuality.

13. The method of claim 9, further comprising:
reforming the filtered response with respect to the query using a large language model (LLM) to rephrase the filtered response into a rephrased response; and
outputting the rephrased response.

14. The method of claim 9, wherein the method for scoring a respective sub-claim of the plurality of sub-claims further comprises:
scoring a sub-score with respect to each document in the set of documents; and
determining the score of the respective sub-claim is based on the sub-scores.

15. The method of claim 14, wherein the method for scoring the respective sub-claim of the plurality of sub-claims further comprises:
computing, for each document in the set of documents, the sub-score based on a combination of a query-document score and a sub-claim-document score.

16. The method of claim 9, further comprising:
generating multiple responses using retrieval-augmented generation with the set of documents; and
for each respective sub-claim of the plurality of sub-claims:
aggregating how frequently the respective sub-claim appears across the multiple responses; and
scoring the respective sub-claim based on the aggregate frequency.

17. A non-transitory computer-readable medium for retrieval-augmented generation with a calibrated quality guarantee, the non-transitory computer-readable medium comprising instructions executable by a processor for:
generating an initial response by applying a query to a model using retrieval-augmented generation that identifies a set of documents relevant to the query and applies the query to the set of documents;
splitting the initial response into a plurality of sub-claims;
scoring each sub-claim of the plurality of sub-claims, the score of each sub-claim being correlated with a quality;
determining a set of validated sub-claims by selecting sub-claims from the plurality of sub-claims having a score above a calibrated threshold, the calibrated threshold providing a statistical guarantee of the quality in the set of validated sub-claims; and
generating a filtered response comprising the set of validated sub-claims.

18. The non-transitory computer-readable medium of claim 17, wherein the instructions are further executable for:
determining the calibrated threshold based on quantiles representing statistical guarantees for excluding all non-positively annotated sub-claims from a set of annotated sub-claims.

19. The non-transitory computer-readable medium of claim 18, wherein the instructions for determining the calibrated threshold further comprises:
automatically generating an annotation for an annotatable sub-claim by providing the annotatable sub-claim, a calibration-stage query, a generated response to the calibration-stage query, and one or more documents to a language model; and
processing, by the language model, an annotation function.

20. The non-transitory computer-readable medium of claim 17, wherein the quality is factuality.
